(19) United States
(12) Patent Application Publication
(10) Pub. No.: US 2002/0140967 A1
(43) Pub. Date: Oct. 3, 2002

(54) Printer and printer adapter used by the same

(76) Inventors: Takayuki Tsuboi, Kanagawa (JP); Yoichi Tosaka, Kanagawa (JP)

Correspondence Address: MORGAN & FINNEGAN, L.L.P., 345 PARK AVENUE, NEW YORK, NY, 10154, US

(21) Appl. No.: 09/951,305

(22) Filed: Sep. 11, 2001

(30) Foreign Application Priority Data
Sep. 12, 2000 (JP) 277371/2000

(51) Int. Cl. B41B 1/00; G06F 15/00

(52) U.S. Cl. 358/1.15; 358/498

(57) ABSTRACT

A printer usable in combination with an image sensing device has a printing portion that prints an image sensed by the image sensing device onto a sheet and delivering the sheet which has been printed, and a storage portion connected to the printing portion and adapted to receive the sheet delivered from the printing portion.

### FIELD OF THE INVENTION

The present invention relates to a printer for printing image data sensed by an image sensing device onto a sheet and delivering the sheet to the outside through a delivery port, and a printer adapter used by the same.

### BACKGROUND OF THE INVENTION

U.S. Pat. No. 4,074,324 and Japanese Patent Laid-Open No. 54-136325 disclose a printer-attached camera, which fetches image information sensed by an electronic image sensing device using solid-state image sensing elements such as CCDs into a memory, and prints it as needed. This printer-attached camera delivers a sheet printed in the camera body to the outside.

The printer-attached camera of this type is advantageous in that the user can select a desired image from its memory and print it at a desired timing after sensing the image, and a picture is not always printed every time an image is sensed, different from a so-called instant camera.

A system has been proposed in which a digital camera and a portable compact printer are combined and are connected to each other when necessary through an interface. This system can print an arbitrary image sensed by the digital camera in the same manner as a printer-attached camera can.

With a printer-attached camera or a compact printer combined with a digital camera, during print operation of delivering a printed sheet to the outside, if an external load acts on the sheet, printing may not be performed properly.

### SUMMARY OF THE INVENTION

The present invention has been made in consideration of the above situation, and has as its object to provide a printer which is used in combination with an image sensing device, prints an image sensed by the image sensing device, and can deliver the printed sheet stably, and a printer adapter used by the same.

According to the present invention, the foregoing object is attained by providing a printer usable in combination with an image sensing device, the printer comprising: (A) a printing portion that prints an image sensed by the image sensing device onto a sheet and delivering the sheet which has been printed; and (B) a storage portion connected to the printing portion and adapted to receive the sheet delivered from the printing portion.

Further, the foregoing object is also to provide a printer adapter usable in combination with an image sensing device and detachable from a printer which prints an image sensed by the image sensing device onto a sheet and delivers the sheet which has been printed, the printer adapter comprising a storage portion for receiving the sheet delivered from the printer.

Other features and advantages of the present invention will be apparent from the following description taken in conjunction with the accompanying drawings, in which like reference characters designate the same or similar parts throughout the figures thereof.

### BRIEF DESCRIPTION OF THE DRAWINGS

The accompanying drawings, which are incorporated in and constitute a part of the specification, illustrate an embodiment of the invention and, together with the description, serve to explain the principles of the invention.

FIG. 1 is a perspective view showing a state wherein a compact printer adapter according to an embodiment of the present invention is mounted on a printer-attached camera;

FIG. 2 is an exploded perspective view of the compact printer adapter of FIG. 1;

FIG. 3 is a partially sectional view schematically showing the printing operation state of the printer-attached camera on which the compact printer adapter according to the embodiment of the present invention is mounted;

FIG. 4 is a partially sectional view schematically showing the delivery state of a sheet in the printing operation of the printer-attached camera on which the compact printer adapter according to the embodiment of the present invention is mounted; and

FIGS. 5A and 5B are views schematically showing states wherein the compact printer adapter according to the embodiment of the present invention is used for other applications.

### DETAILED DESCRIPTION OF THE PREFERRED EMBODIMENT

A preferred embodiment of the present invention will be described in detail in accordance with the accompanying drawings.

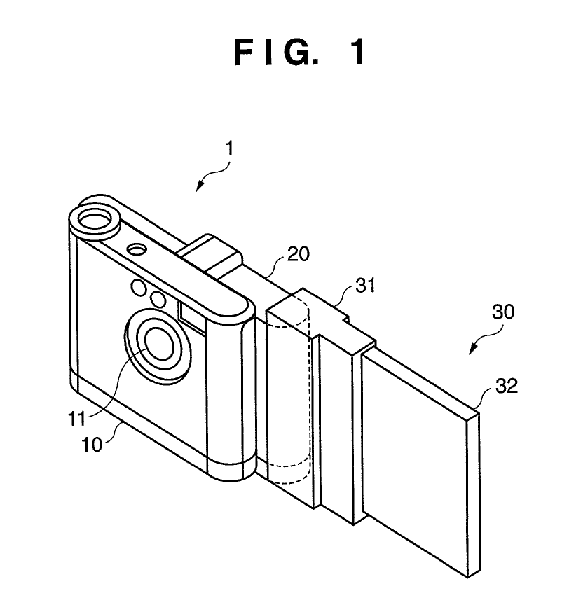

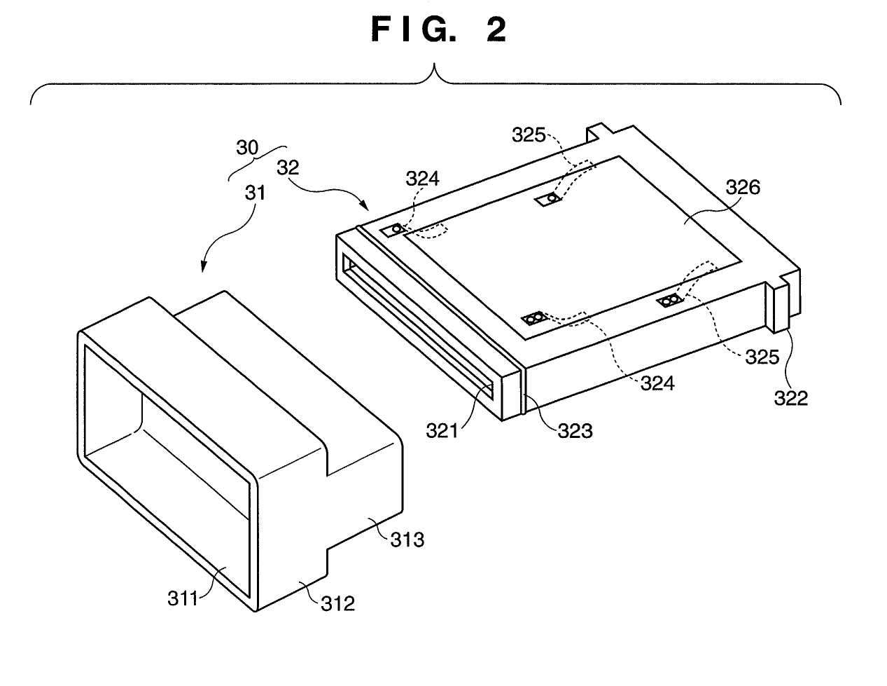

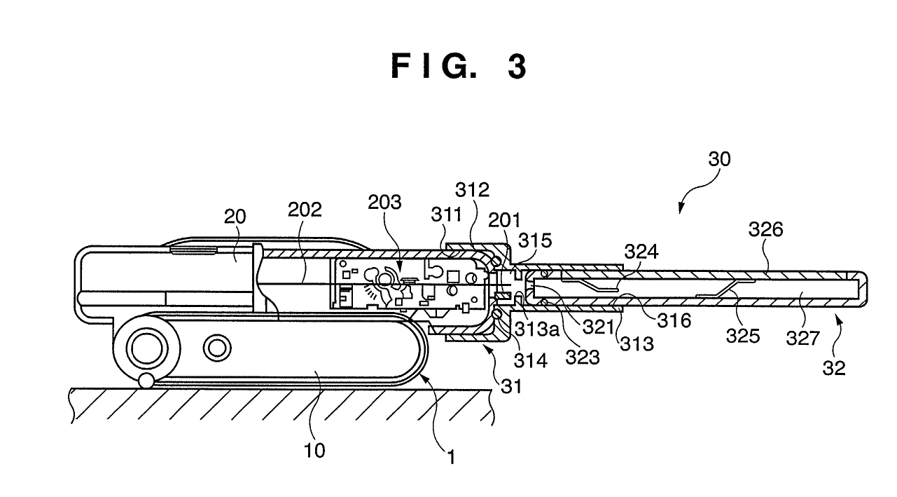

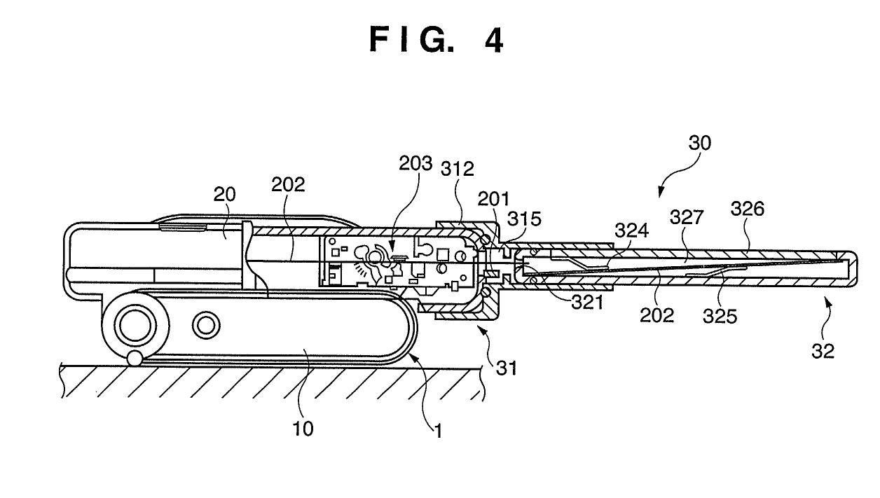

FIG. 1 is a perspective view showing a state wherein a compact printer adapter according to an embodiment of the present invention is mounted on a printer-attached camera, FIG. 2 is an exploded perspective view of the compact printer adapter of FIG. 1, FIG. 3 is a partially sectional view schematically showing the printing operation state of the printer-attached camera on which the compact printer adapter is mounted, and FIG. 4 is a partially sectional view schematically showing the delivery state of a sheet in the printing operation of the printer-attached camera on which the compact printer adapter is mounted.

In this embodiment, a compact printer adapter used by a printer-attached camera will be described. As shown in FIG. 1, a printer-attached camera 1 has a digital camera unit 10 for storing in a memory an image sensed through a lens 11 by using image sensing elements such as CCDs, and a printer unit 20 for printing the image stored in the memory onto a sheet in accordance with the ink-jet printing method and outputting the printed sheet.

The printer unit 20 incorporates a printing mechanism 203 (see FIG. 3) for printing the image onto the sheet. The printer unit 20 has a delivery port lid member 201 (see FIG. 3) on its side surface. During printing, the lid member 201 is opened to form a delivery port through which a sheet 202 (see FIG. 3) is delivered to the outside. A detachable compact printer adapter (to be referred to as an adapter hereinafter) 30 for receiving the delivered sheet is mounted on the printer unit 20. The adapter 30 is comprised of a connecting portion 31 detachable from the printer unit 20, and a storage portion 32 detachable from the connecting portion 31.

The adapter 30 comprises the two portions so that, as will be described later, it can be removed from the printer unit 20 and independently used as a picture stand and that only the storage portion 32 can be used as a portable holder or printed sheet stocker.

As shown in FIG. 2, the connecting portion 31 comprises a large-fitting portion 312 with an opening 311 to receive the printer unit 20, and a small-fitting portion 313 integrally formed with the large-fitting portion 312. The storage portion 32 is formed of a card-like member with a storing space for storing sheets therein, and has an opening 321, in its end face along its short-side direction, for communicating a storing space 327 (see FIG. 3) to the outside. The storage portion 32 is fitted in the small-fitting portion 313 such that its end face where the opening 321 is formed faces the small-fitting portion 313. A seal 323 such as a general O-ring is formed on that surface of the storage portion 32 which is to be fitted in the small-fitting portion 313.

A pair of leaf springs 324 for pressing the delivered sheet 202 (see FIG. 4) at its one surface side and a pair of leaf springs 325 for pressing the delivered sheet 202 at its other surface side are provided in the storage portion 32. The leaf springs 324 and 325 are arranged at a gap along the delivery direction of the sheet 202. Each leaf spring 324 is attached at its one end to the inner surface of the storage portion 32 and extends in a curved manner from this end toward the other end. Each leaf spring 325 is attached at its one end to the inner surface of the storage portion 32 which faces the attaching surface of the leaf springs 324 and extends in a curved manner from this end toward the other end. The forces of the leaf springs 324 and 325 to press the sheet are set such that the sheet is pressed substantially perpendicularly to its traveling direction with a force as weak as about half the total weight of the maximum sheets to be stored in the storage portion 32, so substantially no load acts on the traveling sheet.

Therefore, even if the printer or adapter is held upside down in a user's bag, when the next sheet approaches the current sheet, the current sheet gives way to it, thereby enabling continuous printing.

The storage portion 32 has an opening in its one surface. A transparent window member (e.g., a plastic member; not shown) is fitted in the opening so the interior of the storing space 327 can be seen from the outside. Thus, the presence/absence of the sheet 202 stored in the storing space 327, for instance, can be checked.

The detailed inner arrangement of the adapter 30 will be described. As shown in FIG. 3, an inner space 315 of the large-fitting portion 312 of the connecting portion 31 of the adapter 30 has such a size that the lid member 201 of the printer unit 20 can be opened. Therefore, the adapter 30 can be mounted before the lid member 201 is opened. A seal 314 formed of an O-ring is formed on the inner surface of the large-fitting portion 312 to seal it from the outside. When the large-fitting portion 312 is fitted on the printer unit 20, the seal 314 can prevent water droplets, dust, and the like from entering the printer unit 20 from the outside. The small-fitting portion 313 has an opening 316 for receiving the end of the storage portion 32, and the end of the storage portion 32 is inserted in the opening 316. The small-fitting portion 313 has a collar 313a on its inner surface to prevent the storage portion 32 from being inserted in the small-fitting portion 313 exceeding a predetermined length.

When the storage portion 32 is mounted in the connecting portion 31, the seal 323 provided to the storage portion 32 prevents water droplets, dust, and the like from entering the storing space 327 or printer unit 20 from the outside.

The opening 321 of the storage portion 32 is formed to smoothly decrease in size from the connecting portion 31 toward the storing space 327. Therefore, the sheet 202 is smoothly guided into the storing space 327 without its leading edge being caught by the opening 321.

Continuous printing with the adapter 30 being mounted will be described. To print, as shown in FIG. 3, first, the adapter 30 is mounted on the printer unit 20, and the printer-attached camera 1 is set on the support surface in a predetermined set direction. Subsequently, the print mode is set, printing conditions such as print count are set, and the lid member 201 is opened. When the printing operation is started, a sheet stored in the printer unit 20 is fed to the printing mechanism 203, and the printing mechanism 203 prints an image on the sheet 202 while conveying it in the sub-scanning direction. The sheet printed with the image is fed into the adapter 30.

If only one sheet is to be printed, when this sheet 202 is delivered to the outside of the printer unit 20, it cannot be further delivered toward the outside. In continuous printing, when printing on the current sheet 202 is ended, the next sheet 202 is fed. Thus, for example, the first sheet 202 is further fed deep into the adapter 30 as it is pushed by the second sheet.

Having entered the adapter 30, when the leading edge of the sheet 202 passes under the leaf springs 324, the sheet 202 is fed with its one surface being pressed by the leaf springs 324. When the leading edge of the sheet 202 reaches the leaf springs 325, the sheet 202 is further fed with its other surface being pressed by the leaf springs 325. As shown in FIG. 4, when the trailing edge of the sheet 202 passes through the opening 321, the sheet 202 is pivoted counterclockwise in FIG. 4 by the leaf springs 324 and 325 to give way to the following sheet 202, and the preceding sheet 202 is held in the storing space 327. In this stored state, the sheet 202 is held with its one surface being pressed by the leaf springs 324 and its other surface being pressed by the leaf springs 325.

The next sheet 202 is fed into the adapter 30 in the same procedure. In the storing space 327, this next sheet 202 is stored as it is stacked on the preceding sheet 202 by the pressing operation of the leaf springs 324 and 325.

In this manner, in continuous printing, sheets 202 are stored in the adapter 30 to be stacked in the order they are delivered, so handling of the printed sheets 202 can be easy. Since the adapter 30 can be mounted on and detached from the printer unit 20, the sheet 202 may also be handled as it is stored in the adapter 30.

The sheet 202 delivered from the printer unit 20 is received by the adapter 30. Thus, during printing, no external load acts on the sheet 202, and printing is performed properly. Therefore, the sheet 202 can be delivered stably. Since the adapter 30 can be detached from the printer unit 20, the portability of the printer unit 20, i.e., the printer, is not impaired.

Although not shown, this embodiment has a mechanism for taking the sheet 202 stored in the adapter 30 out of the storage portion 32. As an example of this mechanism, a slide lever that can come into contact with the sheet 202 may be provided to that surface of the storage portion 32 which faces a window member 326. The sheet 202 may be moved toward the opening 321 by sliding this slide lever, and be taken out from the opening 321.

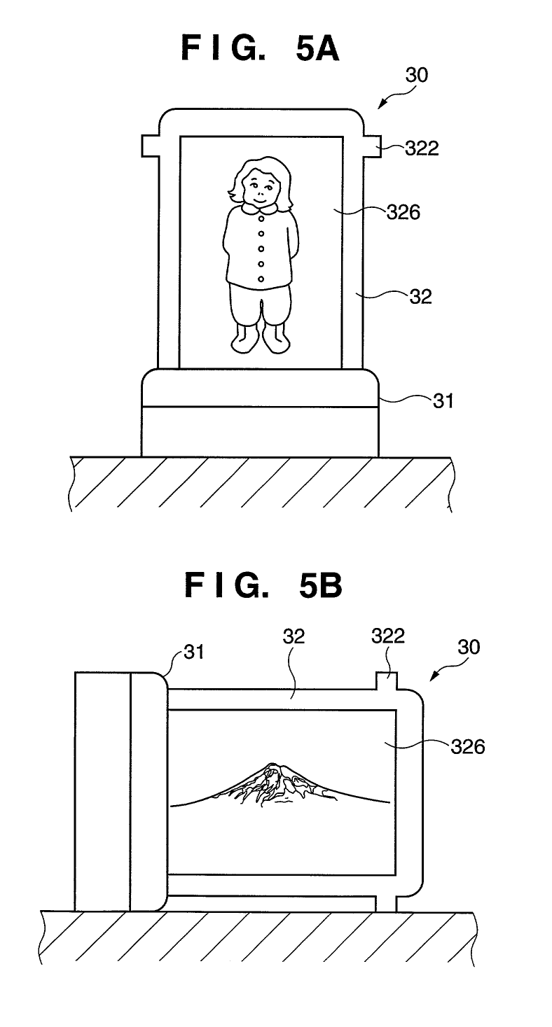

If the adapter 30 has an outer shape as shown in FIGS. 5A and 5B, it can be used as a device for displaying a print image, such as a photostand, so that the printed sheet 202 may be appreciated through the window member 326. Particularly, projections 322 can be used for other usage, e.g., can be effective when the adapter 30 is used as a horizontal stand, as shown in FIG. 5B. Also, the storage portion 32 alone can be used as a portable holder. In this manner, the adapter 30 is of great convenience.

In this embodiment, the adapter 30 which is to be applied to the printer unit 20 of the printer-attached camera 1 has been described. It is a matter of course that the adapter of the present invention can be applied to, e.g., a printer usable in combination with a digital camera.

In this embodiment, the connecting portion 31 and storage portion 32 are formed separately, and can be mounted on and detached from each other. Alternatively, the connecting portion 31 and storage portion 32 may be formed integrally.

Furthermore, if the adapter 30 is of such a type that it is to be fixed to the printer, the present invention can also be applied to it.

As has been described above, according to this embodiment, there is provided a printer which can stably deliver a printed sheet, and a printer adapter.

The present invention is not limited to the above embodiments and various changes and modifications can be made within the spirit and scope of the present invention. Therefore to apprise the public of the scope of the present invention, the following claims are made.

What is claimed is:

1. A printer usable in combination with an image sensing device, the printer comprising:
(A) a printing portion that prints an image sensed by the image sensing device onto a sheet and delivering the sheet which has been printed; and
(B) a storage portion connected to said printing portion and adapted to receive the sheet delivered from said printing portion.

2. The printer according to claim 1, wherein said printing portion is formed integrally with the image sensing device.

3. The printer according to claim 2, wherein said storage portion is detachable from said printing portion.

4. The printer according to claim 1, wherein said storage portion is detachable from said printing portion.

5. The printer according to claim 4, wherein said storage portion has a water-tight structure for maintaining water tightness with respect to said printing portion when said storage portion is mounted on said printing portion.

6. The printer according to claim 4, wherein said storage portion has packing for maintaining water tightness with respect to said printing portion when said storage portion is mounted on said printing portion.

7. The printer according to claim 4, wherein said storage portion has an arrangement that enables said storage portion to be set upright as a device for displaying the printed image when detached from said printing portion.

8. The printer according to claim 4, wherein said storage portion has an arrangement that enables said storage portion to be set both vertically and horizontally as a device for displaying the printed image when detached from said printing portion.

9. The printer according to claim 4, further comprising a connecting portion for connecting said storage portion to said printing portion.

10. The printer according to claim 9, wherein said connecting portion is formed separately from said printing portion and said storage portion.

11. The printer according to claim 1, wherein said storage portion has first and second elastic members for respectively pressing the sheet stored therein from one and the other surface sides thereof, the second elastic member being arranged along a moving direction of the sheet being stored with respect to the first elastic member.

12. The printer according to claim 1, wherein said storage portion has an observation window so that the stored sheet can be seen.

13. The printer according to claim 12, wherein said storage portion has a transparent member for covering the observation window.

14. The printer according to claim 12, wherein the observation window is formed to face at least one surface of the stored sheet.

15. The printer according to claim 1, wherein said storage portion has a sheet receiving port through which the sheet delivered from said printing portion is received, the sheet receiving port being formed to smoothly decrease in size along the moving direction of the sheet being stored.

16. A printer adapter usable in combination with an image sensing device and detachable from a printer which prints an image sensed by the image sensing device onto a sheet and delivers the sheet which has been printed, the printer adapter comprising a storage portion for receiving the sheet delivered from the printer.

17. The printer adapter according to claim 16, further comprising a water-tight structure for maintaining water tightness with respect to the printer when the printer adapter is mounted on the printer.

18. The printer adapter according to claim 16, further comprising packing for maintaining water tightness with respect to the printer when the printer adapter is mounted on the printer.

19. The printer adapter according to claim 16, further comprising an arrangement that enables the printer adapter to be set upright as a device for displaying the printed image when removed from the printer.

20. The printer adapter according to claim 16, further comprising an arrangement that enables the printer adapter to be set both vertically and horizontally as a device for displaying the printed image when detached from the printer.

21. The printer adapter according to claim 16, further comprising a connecting portion for connecting the printer adapter to the printer.

22. The printer adapter according to claim 21, wherein said connecting portion is formed separately from said storage portion.

23. The printer adapter according to claim 16, wherein said storage portion has first and second elastic members for respectively pressing the sheet stored therein from one and the other surface sides thereof, the second elastic member being arranged along a moving direction of the sheet being stored with respect to the first elastic member.

24. The printer adapter according to claim 16, wherein said storage portion has an observation window so that the stored sheet can be seen.

25. The printer adapter according to claim 16, wherein said storage portion has a transparent member for covering the observation window.

26. The printer adapter according to claim 25, wherein the observation window is formed to face at least one surface of the stored sheet.

27. The printer adapter according to claim 16, wherein said storage portion has a sheet receiving port through which the sheet delivered from said printer is received, the sheet receiving port being formed to smoothly decrease in size along the moving direction of the sheet being stored.
